(19) United States
(12) Patent Application Publication
(10) Pub. No.: US 2017/0165857 A1
(43) Pub. Date: Jun. 15, 2017

(54) METHOD AND A MACHINE FOR CUTTING PAPER LOGS

(71) Applicant: FUTURA S.P.A., Capannori (LU), Fraz. Guamo (IT)

(72) Inventors: Ciro GUARINI, Pisa (IT); Roberto GASPARI, Capannori (LU) (IT)

(21) Appl. No.: 15/116,064

(22) PCT Filed: Feb. 3, 2015
(86) PCT No.: PCT/IT2015/000022

§ 371 Date: Aug. 2, 2016

(30) Foreign Application Priority Data
Feb. 6, 2014 (IT) FI2014A000026

(51) Int. Cl. B26D 7/06; B26D 3/16; B26D 7/02; B26D 1/24

(52) U.S. Cl. CPC B26D 7/0683; B26D 1/24; B26D 3/16; B26D 7/02; B26D 2007/013

(57) ABSTRACT

Method for cutting of logs of paper material, wherein the cut is performed by means of two circular blades (11a, lib) rotating about respective axes (x-x) and acting in a cutting plane (T) orthogonal to a plane (P) in which lies the longitudinal axis (y-y) of one or more logs (2) subjected to cutting, and wherein, during execution of the cut, is: DL<W<(R1+R2), where DL is the diameter of the logs, W is a vertical distance between the axes of rotation (x-x) of the two blades, and R1 and R2 are the radii of the two blades, and the log (2) is locked by a group of pressers (4, 40) each of them is a jaw (4, 40) having a concave profile with the concavity turned towards the longitudinal axis (y-y) of said one or more logs (2).

The present invention relates to a method and a machine for cutting paper logs.

In particular, the present invention relates to the transverse cutting of rolls or logs of paper material produced in paper converting plants for the production of rolls of smaller and standardized length such as rolls of toilet paper or kitchen paper.

Examples of cutting machines for cutting the above-mentioned products are provided in EP507750 and EP970784.

In general, the transverse cutting of logs of paper material is made by means of cutting machines having a circular blade oriented and acting in a cutting plane orthogonal to the longitudinal axis of the logs. This blade, in addition to move around its axis, moves along a circular orbit.

The overheating of the blades involves vibrations and deviations of the same blades from the ideal cutting plane and this occurs with greater frequency when particularly dense logs are to be cut, which implies the production of defective products, i.e. products that does not meet the commercial standards and that, therefore, must be discarded.

Another drawback of the known cutting machines concerns the retaining of the logs during cutting. In fact, it is particularly important to maintain the integrity of the logs whose outer surfaces exhibit a very low mechanical strength and are easily subject to damage.

The main purpose of the present invention is to eliminate, or at least reduce, the aforementioned drawbacks.

This result is achieved, according to the present invention, by adopting the idea of making a machine and to implement a method having the characteristics indicated in the independent claims. Other features of the present invention are the object of the dependent claims.

Thanks to the present invention, it is possible to perform the cutting of logs of paper material with greater precision, reducing production waste. Furthermore, the cutting means are subject to thermal and mechanical stress minors also by virtue of the more efficient arrangement of the same. With the present invention, the logs are properly retained during cutting by locking means (pressers) so shaped as to allow the correct locking of the logs without providing damages; in practice, the locking means determine a dual advantage both because they firmly lock the logs during the cutting step, and because they are so shaped and sized to avoid damages to their outer surface. Besides this, there is the fact that the present invention provides a system for the cutting of logs alternative to the conventional systems.

These and other advantages and features of this invention will be best understood by anyone skilled in the art thanks to the following description and to the attached drawings, provided by way of example but not to be considered in a limiting sense, in which:

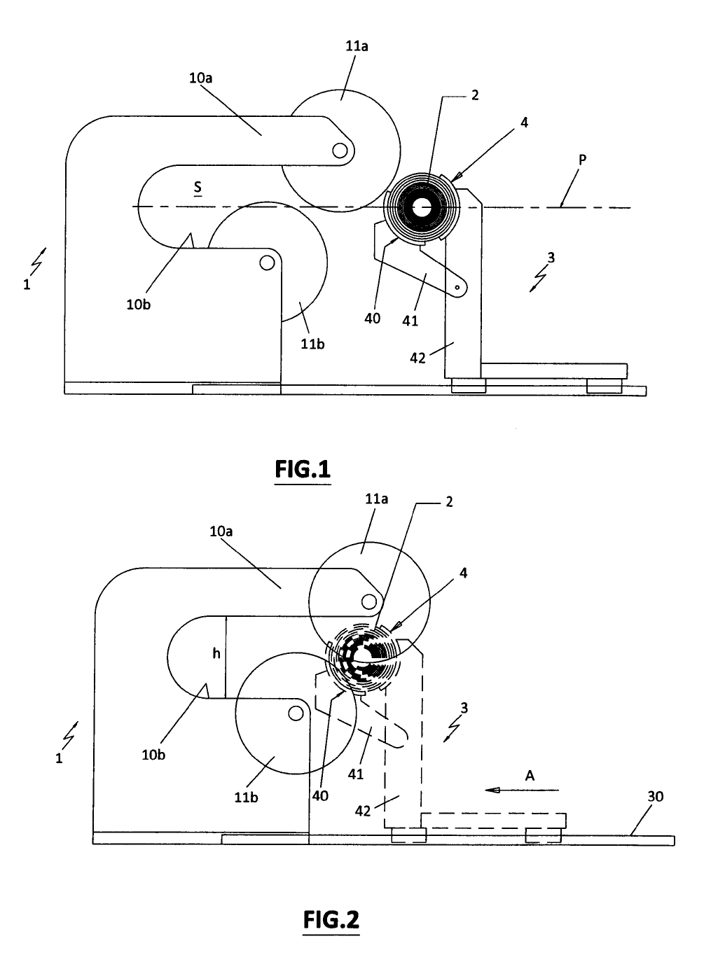

FIG. 1 is a schematic side view of a cutting machine according to the present invention, with the blades spaced from a log to be cut;

FIG. 2 shows the machine of FIG. 1 in the step of cutting the log;

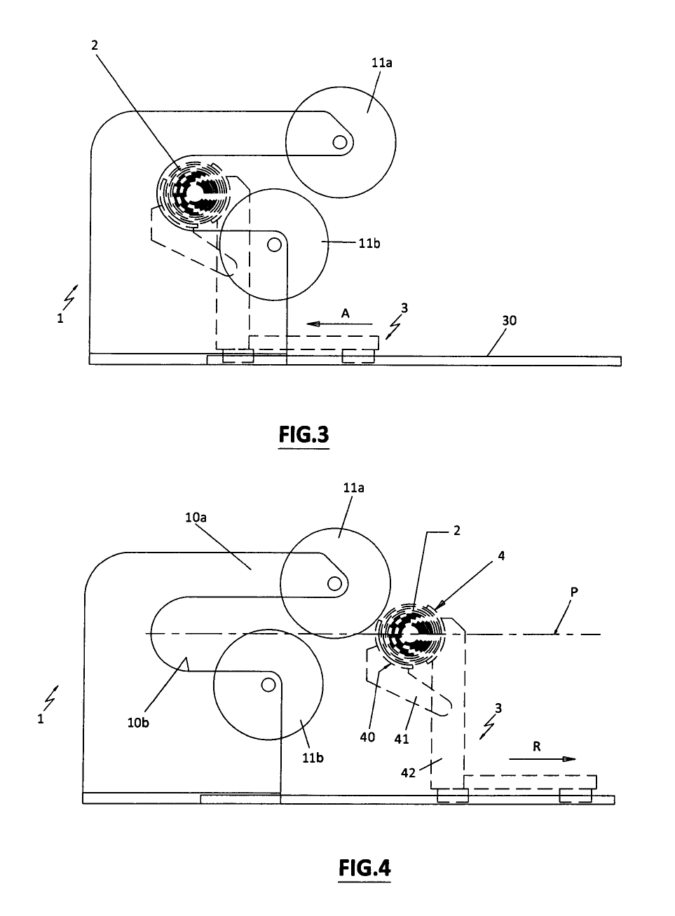

FIG. 3 shows the machine of FIG. 1 and FIG. 2 at the end of the cut;

FIG. 4 shows the cutting machine with the pressers carriage brought to the initial position of FIG. 1;

FIG. 5 is a schematic plan view of the machine in the configuration of FIG. 2, in which the base (1) is not represented for simplification;

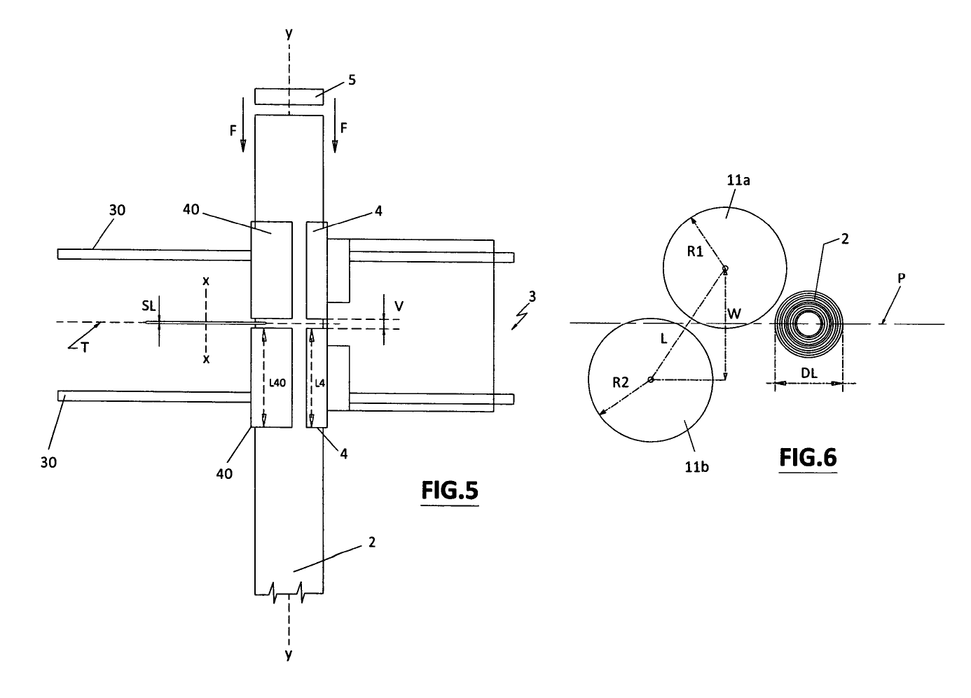

FIG. 6 shows an enlarged detail of FIG. 1;

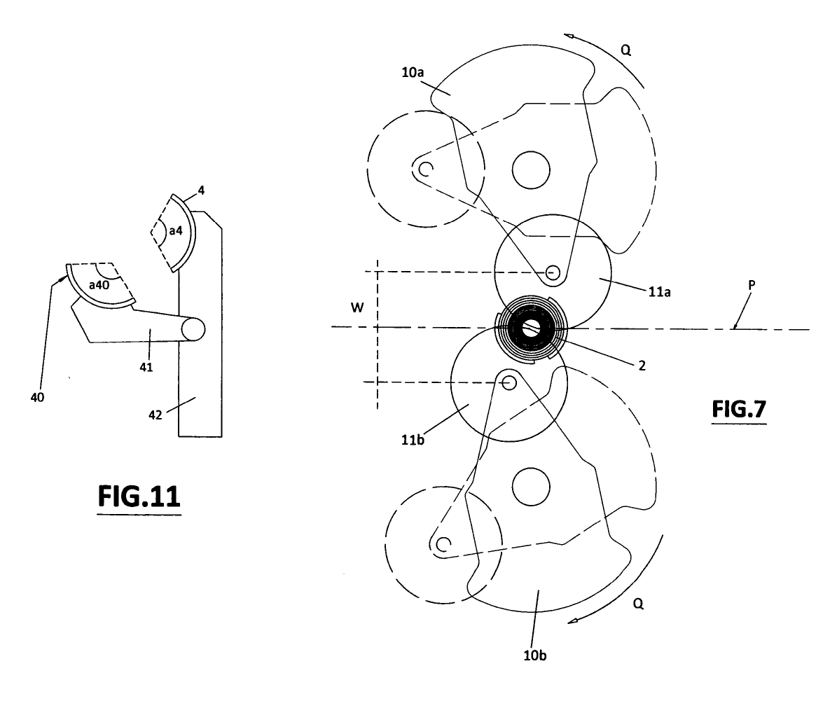

FIG. 7 shows schematically a further embodiment of a cutting machine according to the present invention;

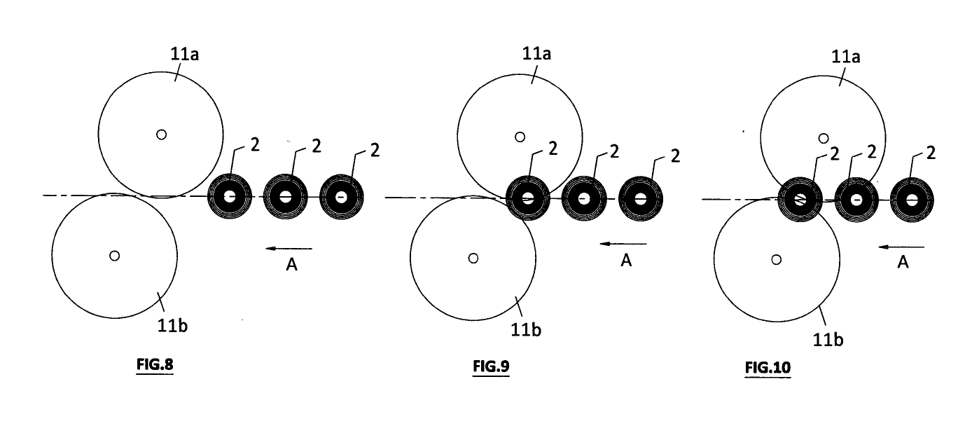

FIGS. 8-10 schematically show a further way of use of a machine in accordance with this invention;

FIG. 11 is a schematic partial side view in which the pressers are better visible and are distanced from each other.

Reduced to its basic structure and with reference to FIGS. 1 to 6 of the attached drawings, a machine according to the present invention comprises:
a fixed structure (1) with two horizontal arms (10a, 10b) each of which, at a free end, supports a corresponding motorized circular blade (11a, 11b) rotating about a respective horizontal axis (x-x), that is orthogonal to the arms (10a, 10b), said arms (10a, 10b) being distanced by a predetermined value (h) so that between them there is a space (S) freely traversable by a log (2) during the cutting of the same as further described below;
a carriage (3) mounted on a driving platform (30), said carriage (3) being movable to and from said space (S) between the arms (10a, 10b) of the structure (1), as indicated by the arrows “A” and “R”;
a group of pressers (4, 40) mounted on said carriage (3) to retain a log (2) during the crossing of said space (S), that is, in the phase of moving the carriage (3), the log being orientated with its longitudinal axis (y-y) parallel to the axes (x-x) of the blades (11a, 11b).

The movement (A, R) of the carriage (3) is orthogonal to the directions of the aforementioned axes (x-x) and (y-y). The carriage (3) moves the log (2) so that the longitudinal axis (y-y) of the latter lies on a horizontal plane (whose trace is indicated with the letter “P” in FIG. 1 and FIG. 6).

The pressers (4, 40) are of the known type consisting, essentially, in a series of jaws openable and closeable on the log (2) to retain it when the latter is subjected to cutting.

In accordance with the present invention, as in the example shown in the attached drawings, each presser is formed by a fixed jaw (4) and a movable jaw (40), the latter being mounted on the end of an arm (41) hinged with horizontal axis on an upright (42) of the carriage (3). Said jaws have a concave profile, with the concavity directed toward the axis (y-y) of the log (2). When the pressers are open, the log (2) is free. When the pressers are closed, the log (2) is bound to the carriage (3). During cutting, the pressers (4, 40) are closed on the log.

The special concave shape of the pressers, which “copy” the outer surface of the log, causes an effective locking of the log, without causing damages to it, logs during the entire cutting operation. Furthermore, as shown in FIG. 5, between two pairs of adjacent pressers (4, 40) there is a slot whose width (V) allows the passage of the blades (11a, 11b) therein. For example, (V)=(SL)+4 mm, wherein (SL) is the thickness of the blade.

The profile of the pressers (4, 40) has the shape of an arc of circumference; the sum of the respective central angles (a4, a40) is greater than 90°. In practice, the angle with which the pressers clamp the log (2) is greater than 90° to ensure an optimum grip of the same log (2).

FIG. 5 shows the axial length of pressers (4, 40), indicated, respectively, with (L4) and with (L40); each of these values (L4, L40) is higher than the value of the diameter (DL) of the log (2). In this way the locking of the logs is further improved, since the pressers exert their action on a wide outer surface of the log, thus causing a more effective gripping action and, at the same time, reducing the pressure locally exerted on the log.

The blades (11a, 11b) are coplanar, i.e. they act in the same cutting plane (T) which is orthogonal to the plane (P) along which the log (2) moves with respect to the blades (11a, 11b). These are connected to an electric motor (not shown in the drawings) that controls the rotation of the blades with a predetermined angular speed about their respective axes.

With reference to the diagram of FIG. 6, said “R1” and “R2” the radii of the blade (11a) and respectively of the blade (11b), and said “DL” the diameter of the log (2), it is DL<W<(R1+R2), where “W” is the vertical distance between the axes of rotation of the blades (11a) and (11b).

With this arrangement of the blades (11a) and (11b), each of them performs the transverse cut of a portion of the log (2), so that the complete transverse cut of the log is made in cooperation by the two blades. Since each blade (11a, 11b) performs only a part of the transversal cutting of log (2), overheating and excessive mechanical stress of the blades is prevented, which allows to cut even logs transversely denser (in which, for the same diameter DL, the amount of paper wrapped to form the log is greater).

For example, R1=R2=175 mm and DL=320 mm. Still, for example, is R1=R2=100 mm and DL=90 mm. The values mentioned above are provided by way of example. Obviously, both R1 and R2, and DL can be higher or lower than the values mentioned above. Furthermore, the present invention contemplates the case that R1≠R2.

Preferably, said “L” the distance between the axes of rotation of the blades (11a) and (11b), it is: L>(R1+R2). In this way, when it is intercepted by the second blade (11b), the log (2) is still subject to the action of the first blade (11a). Therefore, it is obtained a more effective continuity of the cutting action performed in cooperation by the two blades.

A possible example of execution of the transversal cutting of log (2) is the following.

By means of the carriage (3), the log (2) is moved towards the blades (11a, 11b) along the said space (S) so as to be transversely cut by the same blades (11a, 11b), as shown schematically in FIGS. 2 and 3 by the arrow “A”, and then brought back as shown schematically in FIG. 4 by the arrow “R”. In these phases, the pressers (4, 40) are closed and the carriage (3) moves the log (2) so that its axis (y-y) translates along the plane (P).

Subsequently, the pressers (4, 40) are opened and a pusher (5) pushes the log (2) from behind, as indicated by the double arrow “F” in FIG. 5, to advance it to a predetermined step along its own axis (y-y) in order to prepare it for a new cut and the cycle is repeated after having closed the pressers on the log (2).

In an alternative embodiment of a machine in accordance with the present invention, the support assembly of the log (2), that is, the group of pressers, is fixed, while the blades (2) move to and from the group that supports the log. Or, both the group that supports the log (2) and the blades are movable. In any case, there is a relative movement between the blades (11a, 11b) and the log (2).

The blades (11a, 11b) can be made of any suitable material, including metal materials commonly used to make blades for the cutting of logs of paper material, ceramic materials and abrasive materials.

In addition, although the example described above refers to a group of pressers supporting a single log, it is possible to make use of a group pressers supporting a plurality of logs arranged side by side. In this way, increasing the forward stroke (A) of the carriage (3) and increasing the space (S) between the arms (10a, 10b), it will be possible to perform the transverse cut of a plurality of logs (2) before moving the carriage (3) backward (R).

According to the embodiment shown by way of example in FIG. 7, the blades (11a, 11b) are carried by rotating arms (10a, 10b) rather than fixed arms. In other words, the blades (11a, 11b) of the example shown in FIG. 7 are orbital blades, whereby each of them rotates around its own axis and at the same time each of said arms rotates about a different axis.

Even in the case of FIG. 7, when the cutting step is performed, the blades (11a, 11b) satisfy the relation DL<W<(R1+R2), wherein the symbols “DL”, R1 “and” R2” have the same meanings mentioned above, and “W” is the vertical distance between the axes of the blades (11a, 11b) in the time period in which at least one of them is in contact with the log (2). Unlike the previous case, according to the example shown in FIG. 7, the vertical distance between the axes of the blades (11a, 11b) is periodically variable but, nevertheless, in the time period during which at least one of the blades is in contact with the log (2), i.e. during the the transverse cutting of the log, the relation DL<W<(R1+R2) is satisfied. In FIG. 7 the arms (10a, 10b), as the blades (11a, 11b), are drawn in solid lines in the position of execution of the cut and dashed lines out of the execution position of the cut. The arrows “Q” indicate the rotation of the arms (10a, 10b). As in the previous case, the blades (11a, 11b) are coplanar, that is, acting in a cutting plane orthogonal to the plane (P) in which lies the axis (y-y) of the log (2). The arms (10a, 10b) are two distinct arms that rotate about their respective axes with synchronism such as to avoid the interference of the blades (10a, 11b). In this case, during the execution of the cut, the log (2) is stopped.

In accordance with the present invention, therefore, it is provided a method for transversely cutting logs of paper material, in which the cut is performed by means of two circular blades (11a, 11b) acting in a cutting plane (T) orthogonal to a plane in which lies the longitudinal axis (y-y) of a log subjected to cutting, and wherein, during execution of the cut, the following relation is satisfied: DL<W<(R1+R2), where DL is the diameter of the log, W is a vertical distance between the axes of the two blades, and R1 and R2 are the radii of the two blades. With reference to FIGS. 8-10, a machine in accordance with the present invention can also be used for cutting a plurality of logs (2). In particular, FIG. 10 shows the case in which while a log (2) is between the blades (11a) and (11b), a next log is already cut by the upper blade (11a).

In practice the details of execution may vary in any equivalent way as for what concerns the arrangement and the conformation of the individual elements described or illustrated, without thereby departing from the scope of the adopted solution and thus remaining within the limits of the protection conferred by the this patent.

1. A method for cutting of logs of paper material, the method comprising:
performing cutting of logs of paper material by means of two circular blades rotating about respective axes of rotation and acting in a cutting plane orthogonal to a plane in which lies a longitudinal axis of one or more logs subjected to cutting, and wherein, during execution of the cutting, is: DL<W<(R1+R2), where DL is a diameter of the logs, W is a vertical distance between axes of rotation of the two blades, and R1 and R2 are radii of the two blades, and the log is locked by a group of pressers, each of the pressers comprising a jaw having a concave profile with a concavity turned towards the longitudinal axis of said one or more logs.

2. A method according to claim 1, wherein said pressers are applied on a carriage.

3. A method according to claim 1, wherein each group of pressers comprises another jaw, one of said jaw and said another jaw being a fixed jaw and another one of said jaw and said another jaw being a mobile jaw.

4. A method according to claim 1, wherein said concavity has a shape of an arc of circumference, wherein a sum of respective central angles is greater than 90°.

5. A method according to claim 1, wherein said pressers have a length parallel to the longitudinal axis of the logs that is greater than the diameter of the logs.

6. A method according to claim 1, wherein each of said blades is supported by a corresponding fixed arm.

7. A method according to claim 1, wherein each of said blades is supported by a corresponding arm) and each of said arms rotates about a respective fixed horizontal axis.

8. A method according to claim 1, wherein the radii of said blades are equal to each other.

9. A method according to claim 1, wherein during execution of the cutting the logs are subject to a relative advancement with respect to the blades.

10. A method according to claim 1, wherein during the cutting the logs are in a fixed position.

11. A method according to claim 1, wherein during execution of the cutting is: L>(R1+R2), where L is a distance between the axes of the blades.

12. A machine for transverse cutting of logs of paper material, the machine comprising:
two circular blades, rotating about respective axes of rotation and acting in a cutting plane perpendicular to a plane in which lies a longitudinal axis of one or more logs subjected to cutting, wherein in a process of execution of the cutting, is: DL<W<(R1+R2), where DL is a diameter of said log, W is a vertical distance between the axes of rotation of the two blades, and R1 and R2 are radii of the two blades; and
a group of pressers adapted to lock the log and each of the pressers comprising a jaw having a concave profile with a concavity turned towards the longitudinal axis of said one or more logs.

13. A machine according to claim 12, wherein said pressers are applied on a carriage.

14. A machine according to claim 12, wherein each group of pressers comprises another jaw, one of said jaw and said another jaw being a fixed jaw and another one of said jaw and said another jaw being a mobile jaw.

15. A machine according to claim 12, wherein said concave profile has a shape of an arc of circumference, wherein a sum of respective central angles is greater than 90°.

16. A machine according to claim 12, wherein said pressers, have a length parallel to the longitudinal axis of the logs that is greater than a diameter of the logs.

17. A machine according to claim 12, wherein each of said blades is supported by a corresponding fixed arm.

18. A machine according to claim 12, wherein each of said blades is supported by a corresponding arm and each of said fixed arms rotates about a respective horizontal fixed axis.

19. A machine according to claim 12, wherein radii of said blades are equal to each other.
